(19) United States
(12) Patent Application Publication
(10) Pub. No.: US 2026/0066503 A1
(43) Pub. Date: Mar. 5, 2026

(54) COVER PLATE ASSEMBLY, BATTERY CELL, AND BATTERY

(71) Applicants: EVE ENERGY CO., LTD., Huizhou, Guangdong (CN); EVE POWER CO., LTD., Jingmen, Hubei (CN); Eve Energy Storage Co., Ltd., Wuhan, Hubei (CN)

(72) Inventors: Jianhua LIU, Huizhou (CN); Zhenxing FANG, Huizhou (CN); Fei SUN, Huizhou (CN); Xianyang CHEN, Huizhou (CN); Xianyang TAN, Huizhou (CN); Liyuan CHE, Huizhou (CN)

(73) Assignees: EVE ENERGY CO., LTD., Huizhou, Guangdong (CN); EVE POWER CO., LTD., Jingmen, Hubei (CN); Eve Energy Storage Co., Ltd., Wuhan, Hubei (CN)

(21) Appl. No.: 19/318,286

(22) Filed: Sep. 3, 2025

Related U.S. Application Data
(63) Continuation of application No. PCT/CN2025/079985, filed on Feb. 28, 2025.

(30) Foreign Application Priority Data
Sep. 5, 2024 (CN) 202411246740.3
Sep. 5, 2024 (CN) 202422184636.8
Nov. 12, 2024 (CN) 202422761671.1

(51) Int. Cl. H01M 50/586; H01M 50/103; H01M 50/15; H01M 50/176; H01M 50/188; H01M 50/209; H01M 50/531

(52) U.S. Cl. CPC H01M 50/586; H01M 50/103; H01M 50/15; H01M 50/176; H01M 50/188; H01M 50/531; H01M 50/209

(57) ABSTRACT

A cover plate assembly, a battery cell, and a battery are provided, relating to the technical field of batteries. The cover plate assembly includes a cover plate, a lower plastic member, an electrode post, and a tab insulating film. The lower plastic member is connected to the cover plate and is provided with an electrode post clearance hole. The electrode post is fixed to the cover plate and extends through the electrode post clearance hole. The electrode post is provided with a tab connection groove. The tab insulating film is disposed on a side of the lower plastic member facing away from the cover plate and is configured to insulate and isolate a tab of the battery cell from a housing of the battery cell.

This application is a Bypass Continuation Application of PCT/CN2025/079985, filed on Feb. 28, 2025, which claims priorities to Chinese Patent Application No.202411246740.3 and No.202422184636.8, filed with the China National Intellectual Property Administration on Sep. 5, 2024, and Chinese Patent Application No.202422761671.1, filed with the China National Intellectual Property Administration on Nov. 12, 2024. The entire contents of the above applications are incorporated herein by reference.

### TECHNICAL FIELD

The present application relates to the field of battery technology, and more particularly, to a cover plate assembly, a battery cell, and a battery.

### DESCRIPTION OF RELATED ART

Currently, various application scenarios place higher demands on the energy capacity of power batteries. To meet these demands, a key approach is to improve the space utilization within the battery cell to increase the space available for accommodating electrode sheets, thereby enhancing the energy density of the battery cell.

In related technologies, a typical battery cell includes a housing, an electrode assembly arranged within the housing, and a cover plate assembly that seals the opening of the housing. The cover plate assembly includes a cover plate and positive and negative electrode posts extending through the cover plate. The electrode assembly includes a positive electrode sheet, a separator, and a negative electrode sheet stacked sequentially. The electrode sheets are connected to their corresponding electrode posts via conductive connecting tabs.

A height difference typically exists between the electrode sheets and the electrode posts to create space for accommodating the conductive connecting tabs. However, this configuration results in reduced internal space utilization within the battery cell, which negatively impacts its energy density.

### SUMMARY OF INVENTION

Embodiments of the present application provide a cover plate assembly, a battery cell, and a battery, which can improve the internal space utilization of the battery cell.

In a first aspect, embodiments of the present application provide a cover plate assembly for a battery cell. The cover plate assembly includes a cover plate, a lower plastic member, an electrode post, and a tab insulating film. The lower plastic member is connected to the cover plate and is provided with an electrode post clearance hole. The electrode post is fixed to the cover plate and extends through the electrode post clearance hole, and is provided, at its end near the lower plastic member, with a tab connection groove. The tab insulating film is disposed on a side of the lower plastic member facing away from the cover plate and is configured to insulate and isolate a tab of the battery cell from a housing of the battery cell.

In a second aspect, an embodiment of the present disclosure provides a battery cell, including: a housing, an electrode assembly, and a cover plate assembly. The housing includes a receiving cavity. The electrode assembly is disposed in the receiving cavity. A tab with one end connected to the electrode assembly. The cover plate is coupled to the housing. The other end of the tab is located in the tab connection groove and connected to the electrode post, and a portion of the tab insulating film is positioned between the tab and the housing.

In a third aspect, an embodiment of the present disclosure provides a battery. The battery includes a casing assembly and a plurality of battery cells. The casing assembly includes a mounting cavity; and the plurality of battery cells are connected in series and/or in parallel.

### BENEFICIAL EFFECTS

In embodiments of the present application, a tab connection groove is defined on the electrode post, which eliminates the need for a conductive connecting tab. As a result, the space originally used for the conductive connecting tab can be repurposed for accommodating electrode sheets. Furthermore, the tab and the electrode post share a portion of the vertical height space, allowing the space originally used for the tab to also be utilized for arranging electrode sheets. This configuration improves the internal space utilization of the battery cell and consequently enhances its energy density.

### BRIEF DESCRIPTION OF DRAWINGS

FIG. 1 is a schematic structural view of a cover plate assembly according to an embodiment of the present application.

FIG. 2 is a schematic view showing the position of a tab insulating film according to an embodiment of the present application.

FIG. 3 is a schematic structural view of an electrode post according to an embodiment of the present application.

FIG. 4 is an enlarged view of portion A in FIG. 1.

FIG. 5 is a top view of the tab insulating film according to an embodiment of the present application.

FIG. 6 is a schematic structural view showing the tab insulating film assembled to a battery cell according to an embodiment of the present application.

FIG. 7 is another schematic structural view of the electrode post according to an embodiment of the present application.

FIG. 8 is a side view of a second surface of the electrode post according to an embodiment of the present application.

FIG. 9 is a cross-sectional view taken along line E-E in FIG. 8.

FIG. 10 is a schematic view showing the engagement of the electrode post with a tab according to an embodiment of the present application.

FIG. 11 is a schematic structural view of a body of the electrode post according to an embodiment of the present application.

FIG. 12 is a cross-sectional view taken along line B-B in FIG. 8.

FIG. 13 is an enlarged view of portion C in FIG. 12.

FIG. 14 is a side view of a second surface of the electrode post according to another embodiment of the present application.

FIG. 15 is a side view of a second surface of the electrode post according to yet another embodiment of the present application.

FIG. 16 is a cross-sectional view of the electrode post according to the another embodiment of the present application.

FIG. 17 is an exploded view of the cover plate assembly according to an embodiment of the present application.

FIG. 18 is a cross-sectional view of the cover plate assembly according to an embodiment of the present application.

FIG. 19 is an enlarged view of portion D in FIG. 18.

FIG. 20 is a partial schematic structural view of a lower plastic member according to an embodiment of the present application.

FIG. 21 is a schematic structural view of a battery cell according to an embodiment of the present application.

FIG. 22 is a partial schematic structural view of the battery cell according to an embodiment of the present application.

FIG. 23 is a schematic structural view of a battery according to an embodiment of the present application.

### DESCRIPTION OF REFERENCE NUMERALS

1: cover plate assembly; 11: cover plate; 111: first surface;
12: lower plastic member; 121: electrode post clearance hole;
122: first countersink platform; 13: electrode post;
131: tab connection groove; 132: flange; 14: tab insulating film;
141: connection portion; 142: isolation portion; 143: electrode post avoidance hole;
144: exhaust avoidance hole; 145: positioning hole; 146: liquid injection avoidance hole;
15: hot-melt connection portion; 16: press ring; 17: upper plastic member;
18: sealing ring; 2: battery cell; 21: housing; 211: receiving cavity;
22: electrode assembly; 23: tab; 3: battery; 31: casing assembly; 32: mounting cavity.

### DETAILED DESCRIPTION OF EMBODIMENTS OF THE INVENTION

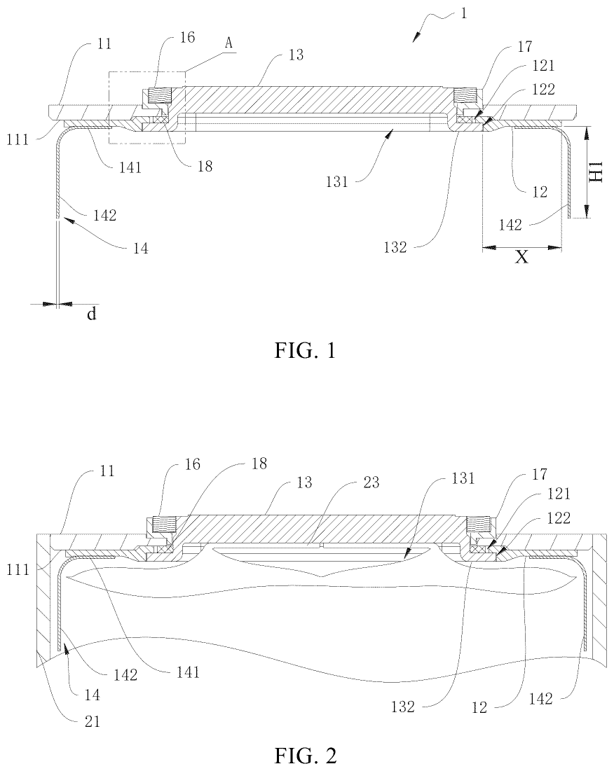

Referring to FIG. 1, which is a schematic structural view of a cover plate assembly 1 according to an embodiment of the present application, the present application provides a cover plate assembly 1 for a battery cell. The cover plate assembly 1 includes a cover plate 11, a lower plastic member 12, an electrode post 13, and a tab insulating film 14. The lower plastic member 12 is connected to the cover plate 11 and includes an electrode post clearance hole 121. The electrode post 13 is fixed to the cover plate 11 and extends through the electrode post clearance hole 121. A tab connection groove 131 is defined at an end of the electrode post 13 adjacent to the lower plastic member 12. The tab insulating film 14 is disposed on a side of the lower plastic member 12 facing away from the cover plate 11 and is configured to insulate and isolate a tab of the battery cell from a housing 21 of the battery cell, as shown in FIG. 2, which is a schematic view showing the position of the tab insulating film 14 according to an embodiment of the present application.

Specifically, the cover plate 11 includes a first surface 111, and the lower plastic member 12 is connected to the first surface 111.

The tab insulating film 14 may be adhesively bonded to the lower plastic member 12 or may be connected to the lower plastic member 12 via hot-melt bonding. Alternatively, the tab insulating film 14 may be connected to the cover plate 11.

The tab of the battery cell is at least partially positioned within the tab connection groove 131 and is welded to an inner wall of the tab connection groove 131, and optionally to a bottom surface of the tab connection groove 131.

In this embodiment, by providing the tab connection groove 131 on the electrode post 13, the need for a conductive connecting tab is eliminated, allowing the space originally used for accommodating the conductive connecting tab to be repurposed for arranging electrode sheets. Furthermore, the tab shares a portion of the vertical space with the electrode post 13, such that the space originally reserved for the tab can also be used to accommodate electrode sheets. In this way, the internal space utilization of the battery cell is improved, thereby increasing its energy density.

In certain application scenarios, the battery cell may be required to include a larger number of tabs, which correspondingly necessitates a larger-sized electrode post 13. When the number of tabs increases, the stacked thickness of the tabs increases accordingly. To reduce the spatial footprint occupied by the tabs, the tabs are bent. However, as the thickness of the tab stack increases, the bending radius also increases, which reduces the distance between the outermost tab and the housing of the battery cell. This reduced distance increases the risk of a short circuit caused by contact between the tab and the housing.

To address this issue, the tab insulating film 14 provided in this embodiment improves insulation between the tab and the housing, thereby reducing the risk of short circuits caused by contact and enhancing the overall reliability of the battery cell.

Furthermore, in this embodiment, a portion of the tab insulating film 14 is connected to the lower plastic member 12 or the cover plate 11 for fixation, while another portion is positioned between the tab and the housing of the battery cell to provide insulation and isolation between the tab and the housing. With this simplified structure, the tab insulating film 14 can effectively reduce material waste and help control the material cost of the battery cell.

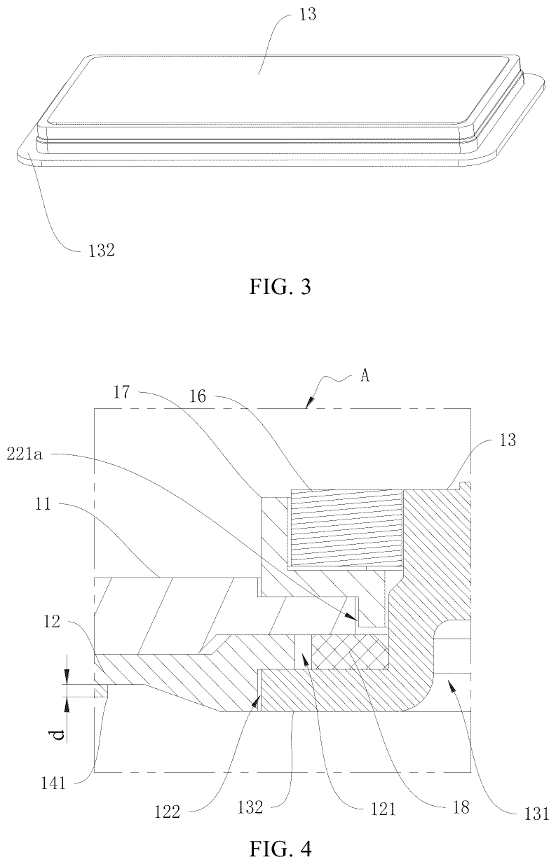

Referring to FIGS. 3 and 4, FIG. 3 is a schematic structural view of the electrode post 13, and FIG. 4 is an enlarged view of portion A in FIG. 1. In one embodiment, a flange 132 is formed on a peripheral sidewall of the electrode post 13. The flange 132 is located adjacent to the opening of the tab connection groove 131 and overlaps with a side of the lower plastic member 12 that faces away from the cover plate 11.

In this embodiment, the flange 132 provides the following effects. First, when the tab is inserted into the tab connection groove 131 and welded to the electrode post 13, the flange 132 supports the portion of the tab located outside the tab connection groove 131. This support helps reduce deformation of the tab during welding, thereby ensuring the flatness of the contact area between the tab and the electrode post 13 and improving the welding reliability between the tab and the electrode post 13. Second, the cover plate 11, in conjunction with the flange 132, clamps and secures the lower plastic member 12, thereby improving the positional stability of the lower plastic member 12 and enhancing the structural reliability of the cover plate assembly 1.

Referring to FIG. 4, in one embodiment, a first countersink platform 122 is provided on a side of the lower plastic member 12 facing away from the cover plate 11. The first countersink platform 122 is arranged around the periphery of the electrode post clearance hole 121. The flange 132 overlaps with a bottom wall of the first countersink platform 122. This configuration increases the structural engagement between the electrode post 13 and the lower plastic member 12, thereby enhancing their fit and improving the structural reliability of the cover plate assembly 1.

Additionally, by placing the flange 132 within the first countersink platform 122, the corresponding portion of the lower plastic member 12 is thickened. This allows the thickness of other portions of the lower plastic member 12 to be reduced in order to control its material usage and overall weight, while maintaining increased thickness at the region where it engages with the electrode post 13. As a result, the thermal impact on the lower plastic member 12 during welding of the electrode post 13 to the tab or other conductive components can be minimized.

Referring to FIG. 4, in one embodiment, the depth of the first countersink platform 122 is equal to the thickness of the flange 132. As such, the portion of the lower plastic member 12 adjacent to the first countersink platform 122 is flush with the end surface of the electrode post 13 where the tab connection groove 131 is formed. This configuration enables the lower plastic member 12 to support the portion of the tab located outside the tab connection groove 131 during welding, thereby reducing deformation of the tab. As a result, the flatness of the contact area between the tab and the electrode post 13 is better ensured, improving welding reliability.

Referring to FIG. 1, in one embodiment, the distance X between the flange 132 and the adjacent outer edge of the lower plastic member 12 satisfies: X≥3 mm.

It is understood that the presence of the flange 132 reduces the distance between the electrode post 13 and the housing 21. Therefore, to ensure adequate insulation distance between the electrode post 13 and the housing 21, the distance X between the flange 132 and the adjacent edge of the lower plastic member 12 is constrained. This prevents the distance X from becoming too small, which would otherwise increase the risk of short circuit, thereby enhancing the electrical reliability of the battery cell.

Referring to FIG. 1, in one embodiment, the tab insulating film 14 includes a connection portion 141 and an isolation portion 142 that are connected to each other. The connection portion 141 is connected to the lower plastic member 12, and the isolation portion 142 extends in a direction away from the cover plate 11. The isolation portion 142 is configured to insulate and isolate the tab of the battery cell from the housing 21, as shown in FIG. 2. This simplified structure facilitates manufacturing and helps control material costs.

Referring to FIG. 1, in one embodiment, the distance H1 between the end surface of the isolation portion 142 facing away from the cover plate 11 and the lower plastic member 12 satisfies H1≥20 mm. Alternatively, the distance H1 may be defined relative to the height H of the battery cell, satisfying the condition: 0.2H≤H1≤0.8H.

The maximum value of H1 is subject to the requirement that it must not interfere with the bottom wall of the housing, while still satisfying H1≥20 mm.

The distance H1 specifically refers to the distance between the end surface of the isolation portion 142 facing away from the cover plate 11 and the portion of the lower plastic member 12 to which the tab insulating film 14 is connected.

In this embodiment, by defining H1 as such, the isolation portion 142 of the tab insulating film 14 is ensured to have sufficient length to enhance insulation between the tab and the housing.

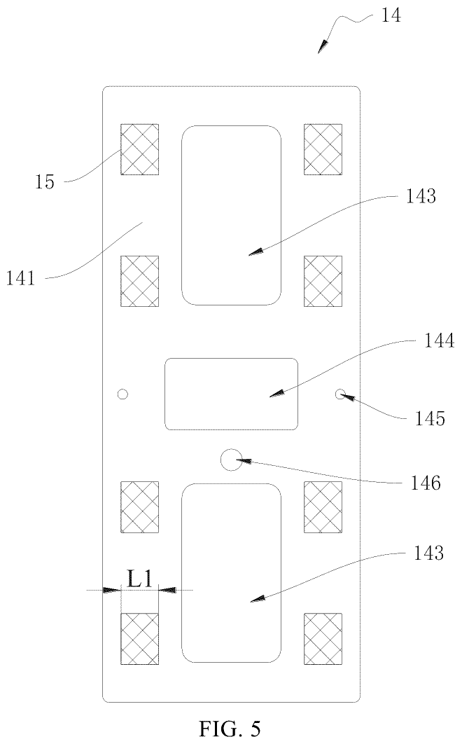

Referring to FIG. 5, which is a top view of the tab insulating film 14, in one embodiment, the tab insulating film 14 is hot-melt bonded to the lower plastic member 12. This eliminates the need for adhesives such as glue, thereby avoiding degradation or connection failure over time. Through heating, the lower plastic member 12 and the tab insulating film 14 are melted and fused into an integral structure, resulting in a stronger and more durable connection.

In one embodiment, in a direction away from the electrode post 13, the hot-melt connection portion 141 between the tab insulating film 14 and the lower plastic member 12 has a length dimension L1, satisfying L1≥3 mm. This configuration ensures the reliability of the hot-melt bond between the tab insulating film 14 and the lower plastic member 12.

The maximum value of L1 is subject to the condition that it must not interfere with other components of the cover plate assembly 1.

Referring to FIG. 1, in one embodiment, the thickness dimension dd0 of the tab insulating film 14 satisfies 0.05 mm≤dd0≤0.5 mm.

It is understood that the thickness dimension dd0 of the tab insulating film 14 may include, but is not limited to, the following values: 0.05 mm, 0.06 mm, 0.08 mm, 0.1 mm, 0.15 mm, 0.19 mm, 0.2 mm, 0.25 mm, 0.28 mm, 0.3 mm, 0.36 mm, 0.4 mm, 0.45 mm, and 0.5 mm.

In this embodiment, by defining the thickness dd0 of the tab insulating film 14, the tab insulating film 14 is ensured to have sufficient mechanical strength to meet insulation requirements while avoiding excessive thickness that could unnecessarily increase material costs.

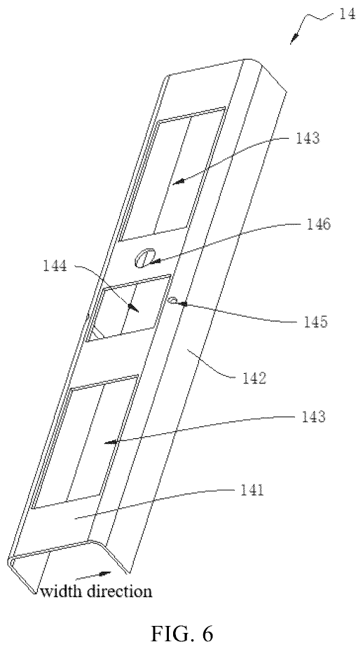

Referring to FIG. 6, which is a schematic structural view illustrating the assembly of the tab insulating film 14 to the battery cell 2, in one embodiment, the battery cell is a prismatic battery cell. Two isolation portions 142 are provided. Along the width direction of the prismatic battery cell, the two isolation portions 142 are respectively located at opposite ends of the connection portion 141 and are connected to the adjacent edges of the connection portion 141.

It is understood that, before bending, the tab in a prismatic battery cell is initially oriented parallel to the major surface of the cell, that is, perpendicular to the width direction of the cell. During the bending process, the end of the tab is folded toward the electrode assembly around the root of the tab, causing the root of the tab to protrude toward the housing along the width direction. As a result, the spacing between the root of the tab and the housing in the width direction becomes relatively small.

Based on this, in the present embodiment, by arranging the isolation portions 142 along the width direction of the prismatic battery cell, when the cover plate assembly 1 is applied to the prismatic cell, insulation between the tab and the housing can be effectively ensured, while maintaining a simple and manufacturable structure for the tab insulating film 14.

The connection portion 141 is provided with an electrode post avoidance hole 143, an exhaust avoidance hole 144, a liquid injection avoidance hole 146, and a positioning hole 145. It is understood that the electrode post avoidance hole 143 is used to accommodate the electrode post 13 to facilitate connection with the tab. The exhaust avoidance hole 144 allows internal gas from the battery cell 2 to pass through for pressure relief via a safety (explosion-proof) valve. The liquid injection avoidance hole 146 facilitates electrolyte filling. The positioning hole 145 engages with a positioning post on the lower plastic member 12, enabling quick alignment of the tab insulating film 14 with the lower plastic member 12 and thereby improving assembly efficiency.

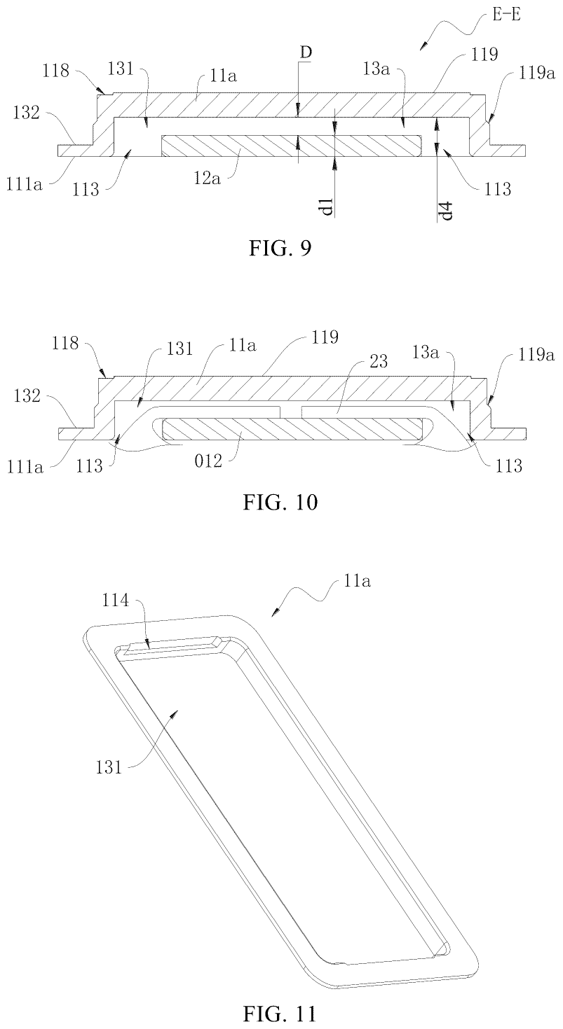

Referring to FIGS. 4 and 7-9, FIG. 7 is a schematic structural view of the electrode post 13; FIG. 8 is a side view of a second surface 111a of the electrode post 13; and FIG. 9 is a cross-sectional view taken along line E-E in FIG. 8. The cover plate 11 is provided with a mounting hole 211a which is arranged corresponding to the electrode post clearance hole 121. The electrode post 13 includes a body 11a and a bottom plate 12a. The body 11a extends through the mounting hole 211a, and the tab connection groove 131 is provided at an end of the body 11a adjacent to the lower plastic member 12. The bottom plate 12a is connected to the body 11a. A tab installation space 13a is defined between the bottom plate 12a and the inner wall of the tab connection groove 131. A first opening 113 is defined by the body 11a and/or the bottom plate 12a, and is configured to communicate the tab installation space 13a with a receiving cavity of the battery cell.

Specifically, the first opening 113 may be defined by the body 11a, the bottom plate 12a, or both the body 11a and the bottom plate 12a.

In detail, the end of the tab passes through the first opening 113 into the tab installation space 13a and is electrically connected to the bottom plate 12a, the body 11a, or both, to enable current flow between the tab and the electrode post 13, as shown in FIG. 10, which is a schematic diagram illustrating the engagement of the electrode post 13 with the tab.

Since the tab is a foil material and has a small thickness, the edges of the surfaces of the bottom plate 12a and the body 11a configured to contact the tab are chamfered. Optionally, the edges of those surfaces configured to contact the tab may be rounded to prevent cutting or damage to the tab.

It is understood that the portion where the bottom plate 12a is connected to the body 11a serves as a current-carrying path between them. Specifically, the bottom plate 12a is welded to the body 11a.

In this embodiment, by defining the tab installation space 13a and the first opening 113 that communicates the tab installation space 13a with the receiving cavity of the battery cell, the tab can pass through the first opening 113 and be positioned within the tab installation space 13a. This configuration, on one hand, allows the tab to share vertical space with the electrode post 13, enabling the space that would otherwise be occupied by the tab to be repurposed for arranging the electrode assembly, thereby increasing the energy density of the battery cell. On the other hand, the tab installation space 13a encloses the tab, and the wall surface of the electrode post 13 that defines the tab installation space 13a isolates the tab's end from the electrode assembly. This effectively prevents the tab from being mistakenly inserted in reverse into the electrode assembly, thereby improving the reliability of the battery cell.

Additionally, in this embodiment, by directly connecting the electrode post 13 to the tab, the conductive connecting tab originally used to link the tab and the electrode post 13 is eliminated. This not only reduces the number of components in the battery cell, thereby controlling costs and improving assembly efficiency, but also allows the space previously occupied by the conductive connecting tab to be repurposed for arranging the electrode assembly, thereby enhancing the energy density of the battery cell.

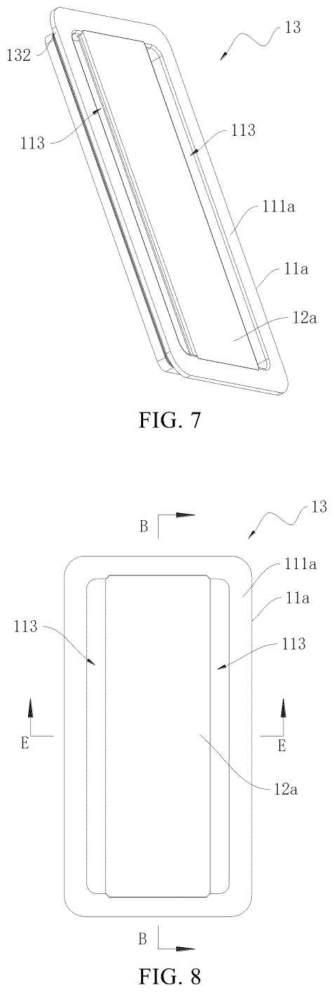

Referring to FIGS. 7-9, in some embodiments, the body 11a includes a second surface 111a that faces the receiving cavity of the battery cell. The tab connection groove 131 is formed on the second surface 111a. The bottom plate 12a spans across the opening of the tab connection groove 131, covering a portion of the opening of the tab connection groove 131, and together with the inner wall of the tab connection groove 131, defines the tab installation space 13a. The remaining uncovered portion of the opening forms the first opening 113.

In an example where the bottom plate 12a is positioned centrally within the opening of the tab connection groove 131, the portions of the opening on either side of the bottom plate 12a each define a respective first opening 113. In this configuration, one portion of the tab enters the tab installation space 13a from one first opening 113, while another portion of the tab enters from the opposite first opening 113. This symmetrical arrangement of the tab improves balance in tab layout and enhances uniformity in mechanical stress distribution within the battery cell.

It is understood that the uncovered periphery of the opening of the tab connection groove 131, together with the adjacent edge of the bottom plate 12a, defines the first opening 113. The space between the bottom plate 12a and the bottom surface of the tab connection groove 131 forms the tab installation space 13a which is configured to receive and accommodate the tab of the battery cell.

It is further understood that the bottom plate 12a is arranged parallel to the opening of the tab connection groove 131 and covers a portion of that opening.

Specifically, the minimum spacing D between the bottom plate 12a and the bottom surface of the tab connection groove 131 satisfies 0.5 mm≤D≤5 mm. The spacing D may be adaptively designed based on the model of the battery and the number of stacked layers of positive and negative tabs.

In this embodiment, by providing the tab connection groove 131 and the bottom plate 12a that partially covers the opening of the tab connection groove 131 and defines the first opening 113, the tab can pass through the gap between the bottom plate 12a and the groove wall of the tab connection groove 131 and be positioned between the bottom surface of the tab connection groove 131 and the bottom plate 12a. This configuration, on one hand, simplifies the structure of the electrode post 13, making it easier to form; on the other hand, it allows the bottom plate 12a to isolate the end of the tab from the electrode assembly, effectively preventing reverse insertion of the tab into the electrode assembly and thereby improving the reliability of the battery cell.

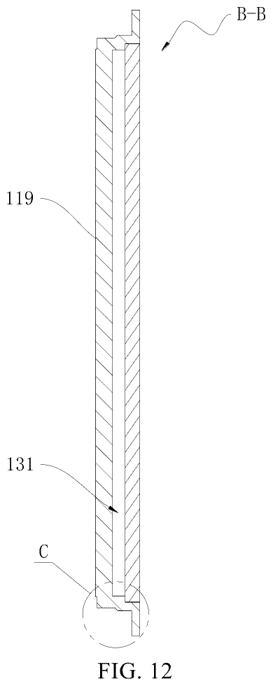

Referring to FIGS. 11 and 12, FIG. 11 is a schematic structural view of the body 11a, and FIG. 12 is a cross-sectional view taken along line B-B in FIG. 8. In one embodiment, first step grooves 114 are formed on opposing inner sidewalls of the tab connection groove 131, adjacent to the opening of the tab connection groove 131. The two ends of the bottom plate 12a overlap with the respective first step grooves 114.

In this embodiment, by providing the first step grooves 114 for engagement with the ends of the bottom plate 12a, the bottom plate 12a can be properly positioned during assembly of the electrode post 13. This improves the assembly efficiency of the electrode post 13 and facilitates smooth welding between the bottom plate 12a and the body 11a. Additionally, the configuration increases the contact area between the body 11a and the bottom plate 12a, thereby enhancing the reliability of current conduction between them.

Referring to FIG. 9 or FIG. 11, in one embodiment, the surface of the bottom plate 12a that faces away from the bottom of the tab connection groove 131 is flush with the second surface 111a. This provides a flat surface of the electrode post 13 facing the receiving cavity of the battery cell, thereby reducing the difficulty of arranging the electrode assembly and allowing the height of the electrode post 13 to be controlled. As a result, the volume available for the electrode assembly can be increased, thereby enhancing the energy density of the battery cell.

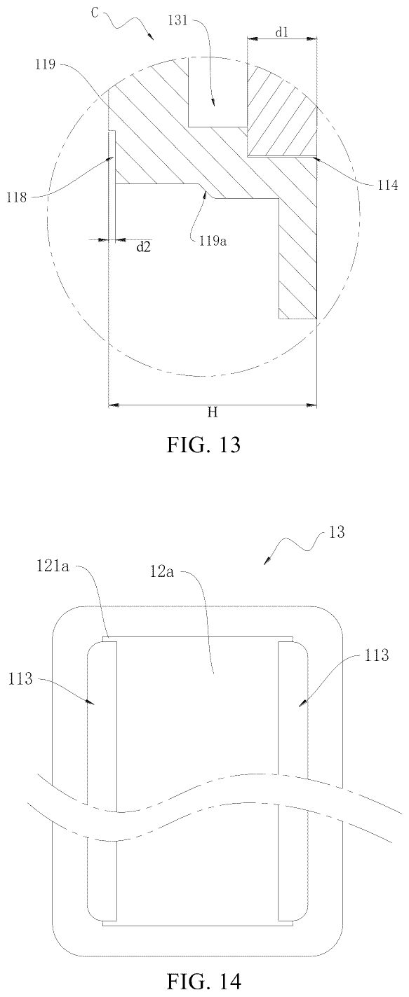

Referring to FIGS. 9 and 13, FIG. 13 is an enlarged view of portion C in FIG. 12. In one embodiment, along the axial direction of the electrode post 13, the bottom plate 12a has a thickness dimension d1, and the tab connection groove 131 has a depth dimension d4, satisfying 30%·d4≤d3≤70%·d4.

It is understood that the thickness d1 of the bottom plate 12a may include, but is not limited to, the following values: 30%·d4, 32%·d4, 33%·d4, 34%·d4, 35%·d4, 38%·d4, 40%·d4, 43%·d4, 48%·d4, 50%·d4, 52%·d4, 54%·d4, 55%·d4, 56%·d4, 58%·d4, 60%·d4, 62%·d4, 64%·d4, 65%·d4, 67%·d4, and 70%·d4.

It is further understood that the thickness d1 of the bottom plate 12a also corresponds to the depth of the first step groove 114.

In this embodiment, by specifying the thickness of the bottom plate 12a, the tab installation space 13a is ensured to have sufficient height to accommodate tab placement. At the same time, the bottom plate 12a is provided with appropriate mechanical strength to meet the insulation requirements between the tab and the electrode assembly. Additionally, the contact area between the bottom plate 12a and the body 11a is maintained at a suitable level to satisfy the current conduction requirements between them.

Referring to FIG. 14, FIG. 14 is a side view of the second surface 111a of the electrode post 13 according to another embodiment of the present application. In one embodiment, along the extension direction of the first step groove 114, an extension portion 121a protrudes from the portion of the bottom plate 12a that overlaps with the first step groove 114. The extension portion 121a overlaps with the first step groove 114.

In this embodiment, by providing the extension portion 121a, the contact area between the bottom plate 12a and the body 11a is increased, thereby enhancing the current-carrying capability between them. In addition, the welding area between the bottom plate 12a and the body 11a is also increased, which improves the welding strength and, consequently, the structural stability of the electrode post 13.

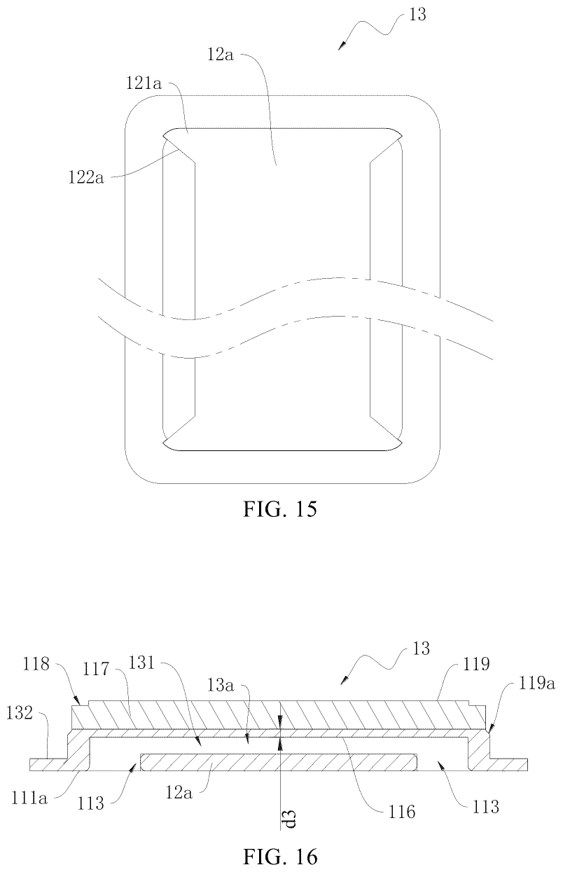

Referring to FIG. 15, FIG. 15 is a side view of the second surface 111a of the electrode post 13 according to yet another embodiment of the present disclosure. In one embodiment, a reinforcing rib 122a is provided at the angle formed between the extension portion 121a and the bottom plate 12a. Two sides of the reinforcing rib 122a are respectively connected to the extension portion 121a and the bottom plate 12a.

In this embodiment, the reinforcing rib 122a enhances the strength of the connection between the extension portion 121a and the body 11a, helping to prevent damage to the extension portion 121a due to impact during assembly. This improves the assembly efficiency of the electrode post 13.

Referring to FIG. 9, in one embodiment, a flange 132 is provided on the outer peripheral surface of the body 11a near the second surface 111a.

It is understood that the flange 132 is a structural feature formed by a radial extension of the outer peripheral surface of the body 11a along the radial direction of the electrode post 13.

In this embodiment, the flange 132 increases the mating area between the electrode post 13 and the top cover of the battery cell, thereby improving the positional stability of the electrode post 13 when installed in the battery cell.

Referring to FIG. 16, FIG. 16 is a cross-sectional view of another electrode post 13 according to an embodiment of the present disclosure. In one embodiment, along the axial direction of the electrode post 13, the body 11a includes a first connecting member 116 and a second connecting member 117. One side of the first connecting member 116 is connected to one side of the second connecting member 117, and the tab connection groove 131 is defined on the opposite side of the first connecting member 116. The bottom plate 12a is connected to the first connecting member 116. The material of the first connecting member 116 and the material of the bottom plate 12a are the same as that of the tab electrically connected thereto, while the second connecting member 117 is made of aluminum.

Specifically, when the negative tab is made of copper, the first connecting member 116 and the bottom plate 12a connected to the negative tab are also made of copper.

The tab connection groove 131 is defined on the side of the first connecting member 116 opposite to the side connected to the second connecting member 117. The portion of the second connecting member 117 located corresponding to the bottom of the tab connection groove 131 is connected to the first connecting member 116. To enhance the connection strength between the first connecting member 116 and the second connecting member 117, optionally, along the axial direction of the electrode post 13, the thickness d3 of the region where the first connecting member 116 is joined to the second connecting member 117 satisfies d3≥0.5 mm, so as to ensure reliable structural strength between the first connecting member 116 and the second connecting member 117 which are made of different materials.

In this embodiment, by configuring the materials of the first connecting member 116 and the bottom plate 12a to be the same as that of the connected tab, electrical conductivity is improved.

Meanwhile, the second connecting member 117 is made of aluminum to reduce the overall weight of the electrode post 13, thereby contributing to control of the battery cell's total weight.

Referring to FIGS. 1, 4, and 13, in one embodiment, the cover plate assembly 1 further includes a press ring 16. The body 11a has a third surface 119 configured to face away from the receiving cavity of the battery cell, with a second step groove 118 provided at the periphery of the third surface 119. A third step groove 119a is provided on the outer peripheral surface of the body 11a. Along the axial direction of the electrode post 13, the second step groove 118 and the third step groove 119a are sequentially positioned away from the third surface 119. The portion of the outer peripheral surface of the body 11a located near the third surface 119 cooperates with the press ring of the battery cell.

It can be understood that the body 11a, on the side facing away from the receiving cavity of the battery cell, needs to be engaged with the press ring 16 to secure the electrode post 13 to the cover plate 11 of the battery cell in the axial direction in conjunction with the flange 132. The press ring 16 needs to be welded to the body 11a, and the weld seam formed by welding have a certain height.

Based on the above, in this embodiment, by providing the second step groove 118, the weld seam formed between the body 11a and the press ring 16 is positioned within the second step groove 118. This improves the flatness of the third surface 119 where the electrode post 13 is welded to the press ring 16, and consequently enhances the flatness of the surface where the electrode post 13 contacts the busbar. As a result, the reliability of welding between the electrode post 13 and the busbar is improved, effectively reducing the risk of cold or incomplete welds.

Referring to FIG. 13, in one embodiment, along the axial direction of the electrode post 13, the second step groove 118 has a depth d2, and the electrode post 13 has a height H, satisfying the condition 2%·H≤d2≤10%·H.

It is understood that the depth d2 of the second step groove 118 may include, but is not limited to, the following values: 2%·H, 2.5%·H, 3%·H, 3.2%·H, 3.8%·H, 4%·H, 4.2%·H, 4.5%·H, 5%·H, 6%·H, 6.2%·H, 7%·H, 7.4%·H, 7.9%·H, 8%·H, 8.2%·H, 8.5%·H, 9%·H, 9.2%·H, 9.7%·H, and 10%·H.

In this embodiment, by specifying the depth of the second step groove 118, it can both accommodate the weld seam to improve the flatness of the third surface 119, and avoid excessive depth that could compromise the structural strength of the electrode post 13.

Referring to FIG. 1, in one embodiment, the cover plate assembly 1 further includes a press ring 16, an upper plastic member 17, and a sealing ring 18. The press ring 16 is mounted on the electrode post 13 and located away from the opening of the tab connection groove 131. The upper plastic member 17 surrounds the electrode post 13 and is located between the press ring 16 and the cover plate 11. The sealing ring 18 surrounds the electrode post 13 and is configured to seal the interface between the electrode post 13 and the cover plate 11.

Specifically, the press ring 16 is welded to the electrode post 13 and cooperates with the flange 132 to fix the electrode post 13 to the cover plate 11. The sealing ring 18 is positioned between the flange 132 and the cover plate 11 and maintained in a compressed state, thereby forming sealing interfaces between the sealing ring 18 and the cover plate 11, and between the sealing ring 18 and the flange 132.

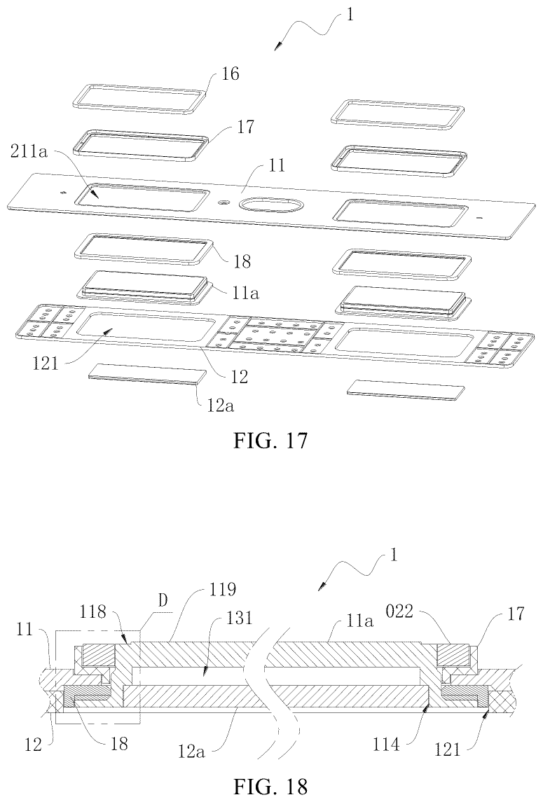

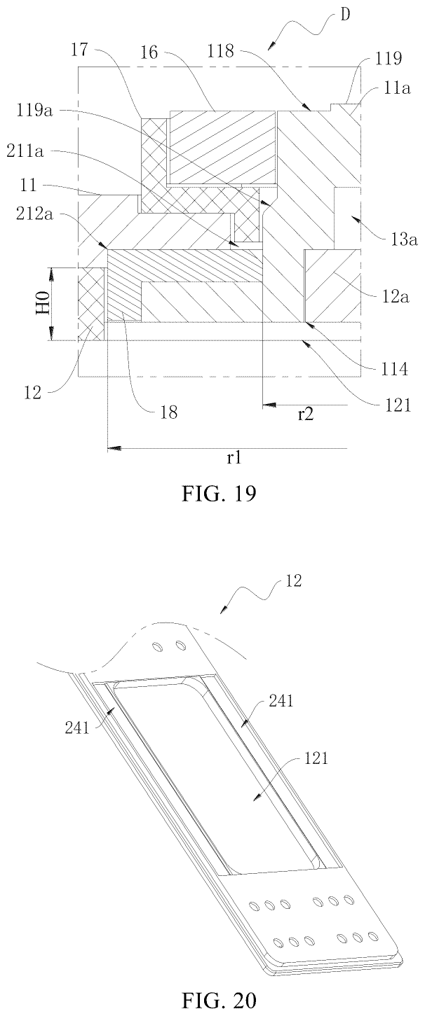

Referring to FIGS. 17 to 19, FIG. 17 is an exploded view of the cover plate assembly, FIG. 18 is a cross-sectional view of the cover plate assembly, and FIG. 19 is an enlarged view of portion D in FIG. 18. In one embodiment, a flange 132 is formed on the outer peripheral surface of the body 11a on the side facing away from the press ring 16. The flange 132 provides a mechanical stop against the cover plate 11. The cover plate 11 has a second countersink platform 212a formed on the side facing the receiving cavity of the battery cell. The mounting hole 211a extends through the bottom wall of the second countersink platform 212a. The inner and outer peripheral surfaces of the sealing ring 18 are configured to sealingly engage the outer peripheral surface of the body 11a and the peripheral wall of the second countersink platform 212a, respectively. The two axial end faces of the sealing ring 18 are configured to sealingly contact the bottom wall of the second countersink platform 212a and the flange 132, respectively.

Specifically, the outer peripheral surface of the flange 132 radially abuts the inner peripheral surface of the sealing ring 18 along the radial direction of the electrode post 13.

In this embodiment, by using the inner and outer peripheral surfaces as well as both axial end surfaces of the sealing ring 18 as sealing interfaces, the sealing performance between the cover plate 11 and the electrode post 13 is enhanced, thereby improving the overall reliability of the battery cell.

Referring to FIG. 19, in one embodiment, the sealing ring 18 has an outer radius r1 and an inner radius r2, satisfying the condition r1-r2≥3 mm.

It is understood that the difference between the outer radius r1 and the inner radius r2 of the sealing ring 18 may include, but is not limited to: 3 mm, 3.2 mm, 3.3 mm, 3.4 mm, 3.5 mm, 3.6 mm, 3.7 mm, 3.8 mm, 3.9 mm, 4 mm, 5 mm, and 6 mm.

Optionally, the value of r1-r2 satisfies 3 mm≤r1-r2≤10 mm.

It is understood that, in related-art designs, the difference between the outer radius r1 and the inner radius r2 of the sealing ring 18 is 2 mm. In this embodiment, after the sealing ring 18 is assembled, the bottom plate 12a needs to be welded to the body 11a, and the welding process may affect the sealing performance of the sealing ring 18. Based on this, the radial dimension of the sealing ring 18 is increased to enlarge the area of the sealing surface in the radial direction, thereby ensuring sealing performance between the cover plate 11 and the electrode post 13 after the bottom plate 12a is welded to the body 11a.

Referring to FIGS. 18 and 19, in one embodiment, the body 11a has a third surface 119 configured to face away from the receiving cavity of the battery cell. The press ring 16 is welded to the body 11a, and the weld seam formed therebetween does not protrude beyond the plane of the third surface 119.

It is understood that the weld seam formed by welding the press ring 16 to the body 11a has a certain height.

Based on this, in this embodiment, by ensuring that the weld seam formed by welding the press ring 16 to the body 11a does not protrude beyond the plane of the third surface 119, the flatness of the third surface 119 where the electrode post 13 is welded to the press ring 16 is improved. This, in turn, enhances the flatness when the electrode post 13 is mated with a busbar, thereby improving the reliability of welding between the electrode post 13 and the busbar and effectively avoiding cold or incomplete welds.

Specifically, a second step groove 118 is provided around the periphery of the third surface 119, allowing the weld seam formed between the body 11a and the press ring 16 to be located within the second step groove 118.

Referring to FIG. 20, which is a partial schematic structural view of the lower plastic member 12 according to an embodiment of the present application, in one embodiment, the side of the lower plastic member 12 facing away from the cover plate 11 is provided with a receiving groove 241. The receiving groove 241 is configured to accommodate a portion of the tab of the battery cell. The receiving groove 241 is disposed adjacent to the electrode post clearance hole 121, and the opening of the receiving groove 241 faces the same direction as the first opening 113.

It can be understood that the lower plastic member is also provided with an electrode post clearance hole 121 for the tab to pass through. The tab sequentially passes through the electrode post clearance hole 121 and the first opening 113 and is located between the bottom plate 12a and the bottom of the tab connection groove 131.

Specifically, the receiving groove 241 is adjacent to the first opening 113 and located on the side of the first opening 113 facing away from the bottom plate 12a. There are two first openings 113, respectively located on both sides of the bottom plate 12a. Correspondingly, there are two receiving grooves 241, respectively located on the side of the two first openings 113 facing away from the bottom plate 12a.

In this embodiment, by providing the receiving groove 241, the lower plastic member 12 not only serves to insulate and protect the electrode assembly and the cover plate 11 but also accommodates bent tabs through the receiving groove 241, effectively preventing reverse insertion of the tab into the electrode assembly.

In one embodiment, the height of the lower plastic member 12 is H0, satisfying H0≥2 mm.

In related-art designs, the minimum height of the lower plastic member 12 is 5 mm to provide sufficient space for accommodating the tab and the conductive connecting tab. In this embodiment, by allowing the tab to share vertical space with the electrode post 13 and by using the bottom plate 12a to separate the tab and prevent reverse insertion into the electrode assembly, the height of the lower plastic member 12 can be reduced to 2 mm. As a result, the present embodiment not only allows for an increase in the size of the electrode assembly, thereby enhancing the energy density of the battery cell but also reduces the material cost of the lower plastic member 12, helping to control the overall cost of the battery cell.

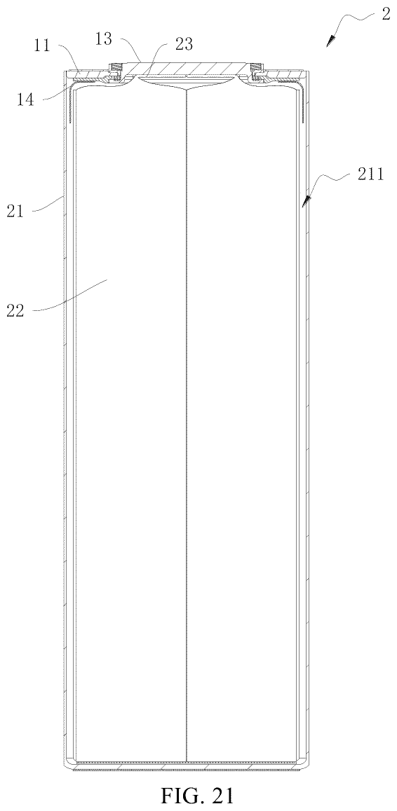

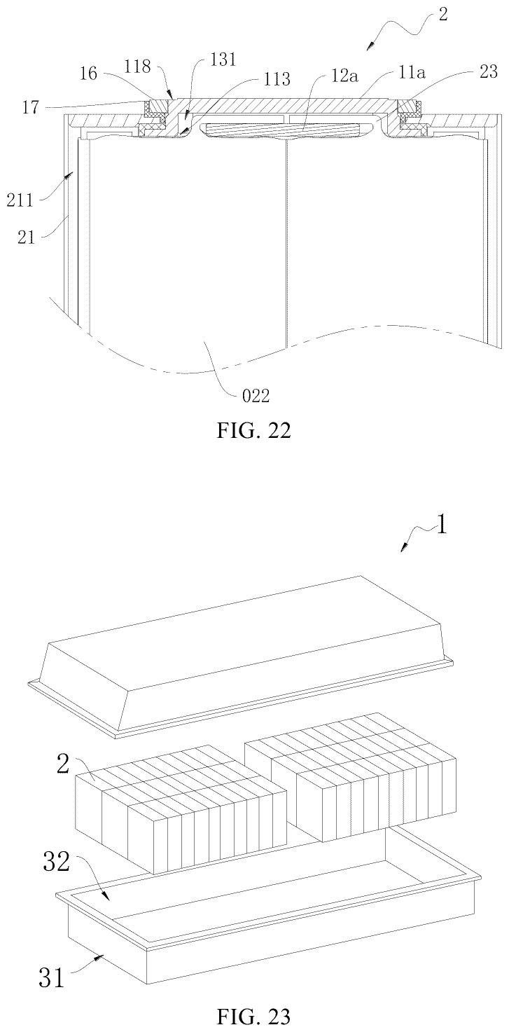

Referring to FIGS. 21 and 22, FIG. 21 is a schematic structural view of a battery cell 2 according to an embodiment of the present application, and FIG. 22 is a partial schematic structural view of the battery cell according to an embodiment of the present application. Accordingly, an embodiment of the present application provides a battery cell 2. The battery cell 2 includes a housing 21, an electrode assembly 22, a tab 23, and the cover plate assembly 1 described in certain embodiments of the present disclosure. The housing 21 defines a receiving cavity 211 in which the electrode assembly 22 is disposed. One end of the tab 23 is connected to the electrode assembly 22. The cover plate 11 is assembled to the housing 21. The other end of the tab 23 is received in the tab connection groove 131 and electrically connected to the electrode post 13. A tab insulating film 14 is disposed between the tab 23 and the housing 21.

Specifically, an isolation portion 142 is located between the tab 23 and the housing 21.

Specifically, the tab 23 is connected to the bottom plate 12a, or the tab 23 is connected to the body 11a, or the tab 23 is connected to both the bottom plate 12a and the body 11a.

It can be understood that the electrode assembly 22 includes a positive electrode sheet, a separator, and a negative electrode sheet stacked sequentially. In a wound-type electrode assembly 22, the positive electrode sheet, separator, and negative electrode sheet are stacked and then wound.

Specifically, the electrode post 13 includes a positive electrode post and a negative electrode post, and the tab 23 includes a positive tab and a negative tab. The positive tab is connected to the positive electrode sheet and the positive electrode post, and the negative tab is connected to the negative electrode sheet and the negative electrode post.

Optionally, the battery cell 2 is a prismatic battery cell. Two electrode assemblies 22 are arranged along the width direction of the prismatic battery cell. The positive tab of one electrode assembly 22 is connected to one inner side wall of the tab connection groove 131 of the positive electrode post, while the positive tab of the other electrode assembly 22 is connected to the opposite inner side wall of the same groove. Likewise, the negative tab of one electrode assembly 22 is connected to one inner side wall of the tab connection groove 131 of the negative electrode post, and the negative tab of the other electrode assembly 22 is connected to the opposite inner side wall.

In this embodiment, by adopting the cover plate assembly 1 as disclosed in certain embodiments of the present application, the conductive connecting tab can be eliminated, allowing the space originally allocated for the conductive connecting tab to be used for arranging electrode sheets. Additionally, the tab 23 shares a portion of the vertical space with the electrode post 13, allowing the space originally occupied by the tab 23 to also be used for arranging electrode sheets. This improves the internal space utilization rate of the battery cell 2, thereby increasing its energy density.

Referring to FIG. 23, FIG. 23 is a schematic structural view of a battery 3 according to an embodiment of the present application. Accordingly, an embodiment of the present application also provides a battery 3, which includes a casing assembly 31 and the battery cells 2 as disclosed in certain embodiments of the present disclosure. The casing assembly 31 defines a mounting cavity 32. A plurality of battery cells 2 are provided and are connected in series and/or in parallel.

In this embodiment, by employing the battery cell 2 disclosed in some embodiments of the present application, the conductive connecting tab can be eliminated, allowing the space originally allocated for the conductive connecting tab to be used for accommodating electrode sheets. Furthermore, the tab 23 shares a portion of the vertical space with the electrode post 13, such that the space originally occupied by the tab 23 can also be used for arranging electrode sheets. This improves the internal space utilization rate of the battery cell 2, thereby increasing the energy density of the battery 3.

What is claimed is:

1. A cover plate assembly for a battery cell, comprising:
a cover plate;
a lower plastic member connected to the cover plate, wherein the lower plastic member is provided with an electrode post clearance hole;
an electrode post fixed to the cover plate and extending through the electrode post clearance hole, wherein the electrode post is provided, at its end adjacent to the lower plastic member, with a tab connection groove; and
a tab insulating film disposed on a side of the lower plastic member facing away from the cover plate, the tab insulating film being configured to insulate and isolate a tab of the battery cell from a housing of the battery cell.

2. The cover plate assembly according to claim 1, wherein the electrode post comprises a peripheral sidewall provided with a flange adjacent to an opening of the tab connection groove, and the flange overlaps with a side of the lower plastic member facing away from the cover plate.

3. The cover plate assembly according to claim 2, wherein the lower plastic member is provided, at the side facing away from the cover plate, with a first countersink platform surrounding a periphery of the electrode post clearance hole, and the flange overlaps with a bottom wall of the first countersink platform.

4. The cover plate assembly according to claim 3, wherein a depth of the first countersink platform matches a thickness of the flange, and a distance between the flange and an adjacent outer edge of the lower plastic member is X, satisfying X≥3 mm.

5. The cover plate assembly according to claim 1, wherein the tab insulating film includes a connection portion and an isolation portion connected to each other, the connection portion is connected to the lower plastic member, the isolation portion extends away from the cover plate, and the isolation portion is configured to insulate and isolate the tab of the battery cell from the housing of the battery cell.

6. The cover plate assembly according to claim 5, wherein a distance between an end surface of the isolation portion facing away from the cover plate and the lower plastic member is H1, satisfying H1≥20 mm, or wherein the distance H1 and a height H of the battery cell satisfy 0.2H≤H1≤0.8H.

7. The cover plate assembly according to claim 6, wherein the tab insulating film is hot-melt bonded to the lower plastic member, wherein, along a direction away from the electrode post, a hot-melt connection portion between the tab insulating film and the lower plastic member has a length L1, satisfying L1≥3 mm, and a thickness of the tab insulating film is dd0, satisfying 0.05 mm≤dd0≤0.5 mm.

8. The cover plate assembly according to claim 7, wherein the battery cell is a prismatic battery cell, the isolation portion comprises two isolation portions respectively located at opposite ends of the connection portion along a width direction of the prismatic battery cell, and each isolation portion is connected to an adjacent edge of the connection portion.

9. The cover plate assembly according to claim 1, wherein the cover plate comprises a mounting hole aligned with the electrode post clearance hole, and the electrode post comprises:
a body extending through the mounting hole, the tab connection groove being provided at an end of the body adjacent to the lower plastic member; and
a bottom plate connected to the body, wherein a tab installation space is defined between the bottom plate and an inner wall of the tab connection groove, and the body and/or the bottom plate defines a first opening configured to communicate the tab installation space with a receiving cavity of the battery cell.

10. The cover plate assembly according to claim 9, wherein the body comprises a second surface facing the receiving cavity of the battery cell, and the tab connection groove is defined on the second surface;
the bottom plate spans an opening of the tab connection groove and covers a portion of the opening of the tab connection groove, the bottom plate and the inner wall of the tab connection groove defining the tab installation space, and a remaining portion of the opening of the tab connection groove forming the first opening.

11. The cover plate assembly according to claim 10, wherein opposite sidewalls of the tab connection groove are provided with first step grooves adjacent to the opening, and opposite ends of the bottom plate respectively engage with the two first step grooves.

12. The cover plate assembly according to claim 9, wherein the bottom plate comprises a surface facing away from a bottom of the tab connection groove is flush with the second surface; and
wherein, along an axial direction of the electrode post, the bottom plate has a thickness d1, and the tab connection groove has a depth d4, satisfying 30% d4≤d1≤70% d4.

13. The cover plate assembly according to claim 11, wherein, along an extension direction of the first step groove, an extension portion protrudes from a portion of the bottom plate that overlaps with the first step groove, the extension portion overlaps with the first step groove; a reinforcing rib is provided at an angle formed between the extension portion and the bottom plate, and two sides of the reinforcing rib are respectively connected to the extension portion and the bottom plate.

14. The cover plate assembly according to claim 9, further comprising a press ring, wherein the body comprises a third surface facing away from the receiving cavity of the battery cell, a periphery of the third surface is provided with a second step groove;
a third step groove is defined on an outer peripheral surface of the body; and along an axial direction of the electrode post, the second step groove and the third step groove are sequentially positioned away from the third surface, a portion of the outer peripheral surface of the body located on a side of the third step groove adjacent to the third surface is configured to engage with the press ring, wherein, along the axial direction of the electrode post, the second step groove has a depth d2, and the electrode post has a height H, satisfying 2% H≤d2≤10% H.

15. The cover plate assembly according to claim 9, further comprising a press ring, an upper plastic member, and a sealing ring, wherein the press ring is sleeved onto the electrode post and positioned away from an opening of the tab connection groove, the upper plastic member is sleeved onto the electrode post and located between the press ring and the cover plate, and the sealing ring is sleeved onto the electrode post and seals a mating portion between the electrode post and the cover plate.

16. The cover plate assembly according to claim 15, wherein an outer peripheral surface of the body on a side facing away from the press ring is provided with a flange that stops against the cover plate, a side of the cover plate facing away from the press ring is provided with a second countersink platform, and the mounting hole extends through a bottom wall of the second countersink platform; an inner peripheral surface and an outer peripheral surface of the sealing ring respectively seal against the outer peripheral surface of the body and a peripheral wall of the second countersink platform, and two end surfaces of the sealing ring respectively sealing against the bottom wall of the second countersink platform and the flange, wherein the sealing ring has an outer radius r1 and an inner radius r2, satisfying r1-r2≥3 mm.

17. The cover plate assembly according to claim 15, wherein the body comprises a third surface facing away from the receiving cavity of the battery cell, the press ring being welded to the body, and a weld seam form the welding does not protrude beyond a plane of the third surface.

18. The cover plate assembly according to claim 1, wherein a side of the lower plastic member facing away from the cover plate is provided with a receiving groove configured to accommodate a portion of the tab of the battery cell, and the receiving groove is disposed adjacent to the electrode post clearance hole.

19. A battery cell, comprising:
a housing defining a receiving cavity;
an electrode assembly disposed in the receiving cavity;
a tab, one end of the tab connected to the electrode assembly; and
the cover plate assembly according to claim 1, the cover plate being coupled to the housing;
wherein another end of the tab is located in the tab connection groove and connected to an inner wall of the electrode post, and a portion of the tab insulating film is positioned between the tab and the housing.

20. A battery, comprising:
a casing assembly comprising a mounting cavity; and
the battery cell according to claim 19, wherein a plurality of the battery cells are provided, the plurality of battery cells being connected in series and/or in parallel.
